(19) United States
(12) Patent Application Publication
(10) Pub. No.: US 2013/0325952 A1
(43) Pub. Date: Dec. 5, 2013

(54) SHARING INFORMATION

(71) Applicants: Sagiv DRAZNIN, Walnut Creek, CA (US); Lalit R. KOTECHA, San Ramon, CA (US); Patricia R. CHANG, San Ramon, CA (US); Thomas W. HAYNES, San Ramon, CA (US); David CHIANG, Fremont, CA (US); John F. MACIAS, Antelope, CA (US)

(72) Inventors: Sagiv DRAZNIN, Walnut Creek, CA (US); Lalit R. KOTECHA, San Ramon, CA (US); Patricia R. CHANG, San Ramon, CA (US); Thomas W. HAYNES, San Ramon, CA (US); David CHIANG, Fremont, CA (US); John F. MACIAS, Antelope, CA (US)

(73) Assignees: CELLCO PARTNERSHIP D/B/A VERIZON WIRELESS, Basking Ridge, NJ (US); VERIZON PATENT AND LICENSING INC., Basking Ridge, NJ (US)

(21) Appl. No.: 13/488,714

(22) Filed: Jun. 5, 2012

(51) Int. Cl. G06F 15/16

(52) U.S. Cl. 709/204

(57) ABSTRACT

A server is configured to receive a portion of content from a first user device, where the portion of content is less than an entirety of content that is playing on the first user device; receive information identifying a second user device with which to share the portion of content; store the portion of content; send a request to the second user device to share the portion of content that is playing on the first user device; receive an acceptance of the request from the second user device; determine whether the portion of content is compatible for playing on the second user device; and send, based on the determination that the portion of content is compatible for playing on the second user device, the portion of content, playing on the first user device, to the second user device, to cause the second user device to play the portion of content.

### BACKGROUND

There has been a substantial growth in different types of devices that can play content. In recent years, devices such as phones, tablets, laptops, and other devices have broadened the opportunities for allowing users to play content on different devices. The ability to play content on a variety of different devices has increased the ability of users to view content virtually anywhere.

### BRIEF DESCRIPTION OF DRAWINGS

FIG. 1 is a diagram of an overview of an implementation described herein;

FIGS. 2A-2B are diagrams of example environments in which systems and/or methods described herein may be implemented;

FIG. 3 is a diagram of example components of one or more devices of FIGS. 2A-2B;

FIG. 4 is a flow chart of an example process for sending and receiving content;

FIG. 5 is a flow chart of an example process for sending and receiving content from an application server;

FIG. 6 is a diagram of an example data structure that stores content information;

FIGS. 7A-7B are diagrams of example processes for sharing content; and

FIGS. 8A-8C are diagrams of an example process for sharing content.

### DETAILED DESCRIPTION OF PREFERRED EMBODIMENTS

The following detailed description refers to the accompanying drawings. The same reference numbers in different drawings may identify the same or similar elements.

Systems and/or methods described herein may share content, playing on one user device, for playing on another user device. For example, a first user device may play content, such as a movie. The first user device may share content with a second user device. The first user device may send a request to the second user device that the user of the first user device would like to share content playing on the first user device. The second user device may accept the request and play the content that is being played on the first user device.

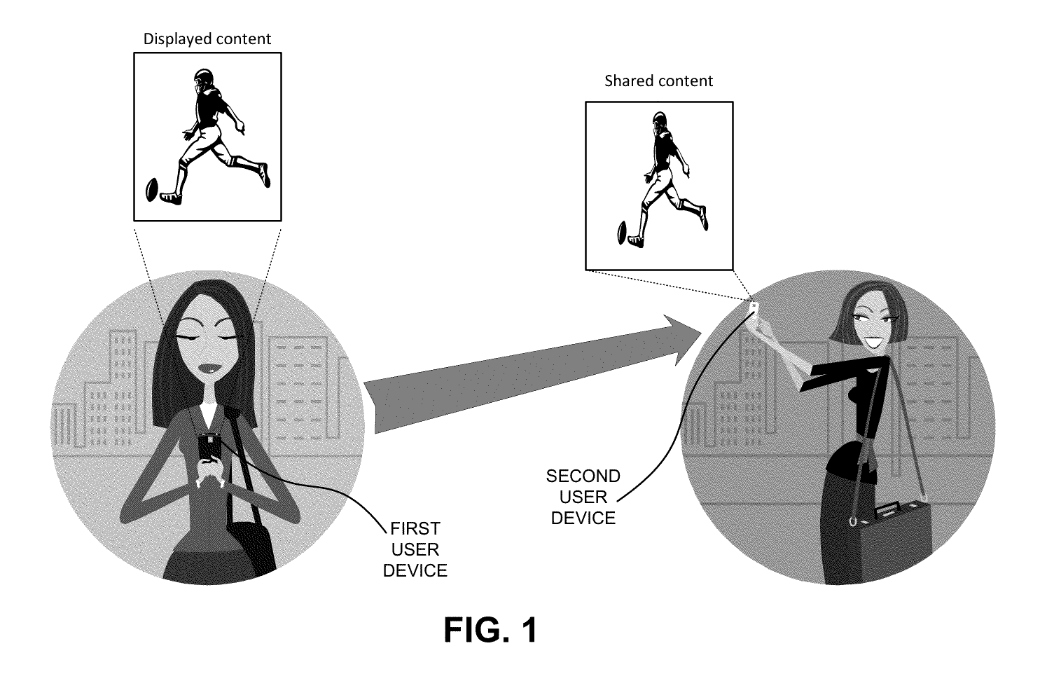

FIG. 1 is a diagram of an overview of an implementation described herein. FIG. 1 shows a first user device and a second user device. In practice, there may be additional or fewer user devices. As shown in FIG. 1, the first user device may play content, such as a video. The first user device may share the content, playing on the first user device, with the second user device. The first user device may send a request to a user of the second user device that the first user device has content that a user of the first user device would like to share with a user of the second user device. The second user device may accept the request from the first user device to share content playing on the first user device. Upon accepting the request to share content from the first user device, the first user device may determine whether the content is compatible with the second user device. If the content is not compatible, the first user device, or the second user device, may transcode the content so that the content may be played on the second user device. The first user device may transmit the content to the second user device. The second user device may play the content that is being played on the first user device.

As a result, a user of the first user device may be able to share content, playing on the first user device, with a user of the second user device without both users having to be in the same location.

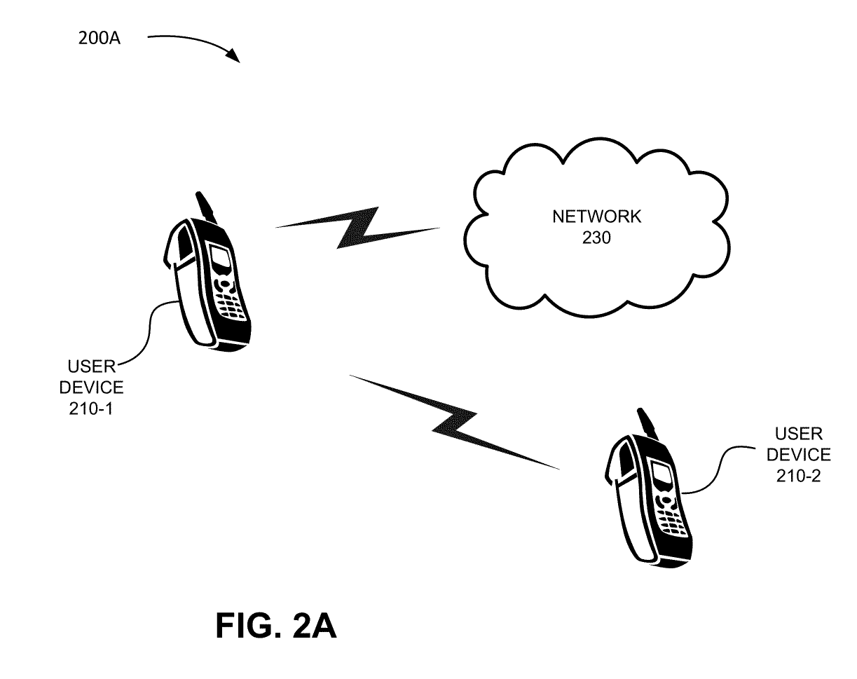

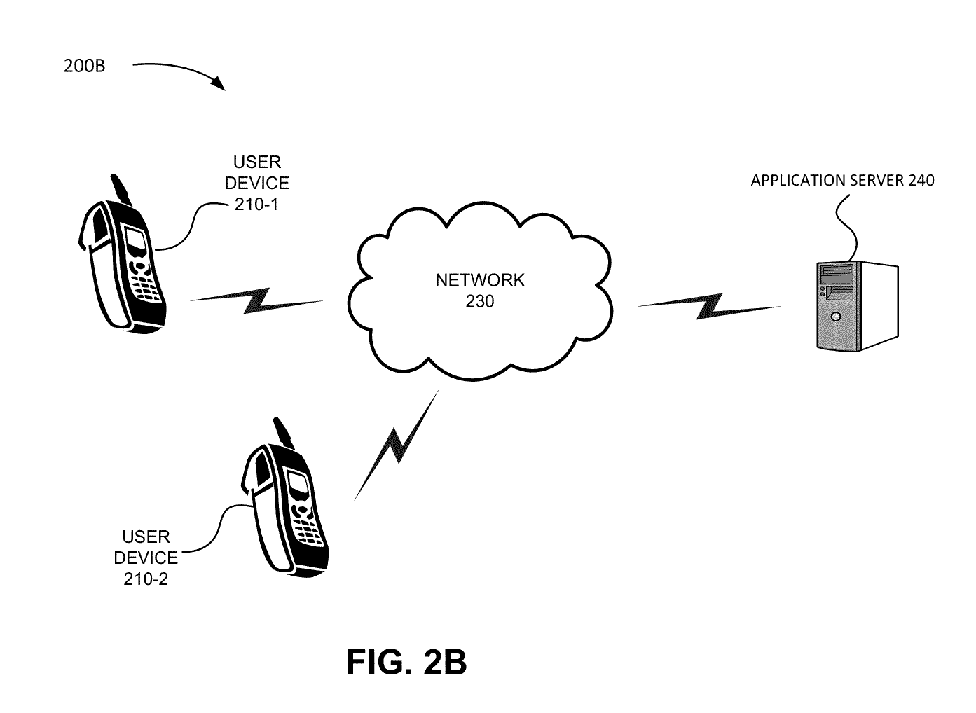

FIGS. 2A-2B are diagrams of example environments 200A and 200B, respectively, in which systems and/or methods described may be implemented. The quantity of devices and/or networks illustrated in FIGS. 2A-2B is provided for explanatory purposes only. In practice, there may be additional devices and/or networks; fewer devices and/or networks; different devices and/or networks; or differently arranged devices and/or networks than illustrated in FIGS. 2A-2B. Also, in some implementations, one or more of the devices in environments 200A and 200B may perform one or more functions described as being performed by another one or more of the devices in environment 200A and 200B. Devices of environment 200A and 200B may interconnect via wired connections, wireless connections, or a combination of wired and wireless connections.

As shown in FIG. 2A, environment 200A may include a user device 210-1, a user device 210-2, and a network 230. User device 210-1 and/or user device 210-2 (referred to collectively as “user devices 210” and individually as “user device 210”) may include any computation or communication device, such as a wireless mobile communication device that is capable of communicating with a network (e.g., network 230). For example, user device 210 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a laptop computer, a tablet computer, a camera, a personal gaming system, a television, a set top box, a digital video recorder (DVR), or another type of mobile computation or communication device.

The content played on user device 210 is intended to be broadly interpreted to include any computer readable data that may be transferred over a network. Content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream).

User device 210 may include a variety of applications, such as, for example, a content sharing application, an e-mail application, a telephone application, a camera application, a video application, a multi-media application, a music player application, a visual voicemail application, a contacts application, a data organizer application, a calendar application, an instant messaging application, a texting application, a web browsing application, a location-based application (e.g., a GPS-based application), a blogging application, and/or other types of applications (e.g., a word processing application, a spreadsheet application, etc.). Various features of some of the above applications may be part of the content.

Network 230 may include one or more wired and/or wireless networks. For example, network 230 may include a cellular network, a public land mobile network (PLMN), a second generation (2G) network, a third generation (3G) network, a fourth generation (4G) network, a fifth generation (5G) network and/or another network. Additionally, or alternatively, network 230 may include a local area network (LAN), wide area network (WAN), a metropolitan network (MAN), a telephone network (e.g., the Public Switched Telephone Network (PSTN)), an ad hoc network, an intranet, the Internet, a satellite network, a GPS network, a fiber optic-based network (e.g., FIOS), and/or combination of these or other types of networks. Additionally, or alternatively, network 230 may include a radio access network (RAN), such as a long term evolution (LTE) network, that may include a variety of components to facilitate mobile communications, such as antennas, base stations, mobile switching centers, and interfaces with Public Switched Telephone Networks (PSTNs) and/or packet data servicing nodes (PDSNs).

Additionally, or alternatively, the communication between user devices 210 may use a short range wireless standard, such as Bluetooth™. Bluetooth™ is a known radio standard and communications protocol primarily designed for low power consumption over relatively short ranges. Bluetooth™-enabled devices can be configured to automatically discover and connect with other devices within range. The term “Bluetooth,” as used herein, may refer to a standard for short range communication. Depending on context, Bluetooth™ may also refer to a Bluetooth™ device, a Bluetooth™ component, or a hardware and/or software interface that conforms to the Bluetooth™ standard.

Additionally, or alternatively, the communication between user devices 210 and/or network 230 may use another type of wireless local area network, such as a network based on ultra wide band (e.g., bandwidth>500 MHz) communications. Examples of standards that are based on ultra wide band (UWB) may include wireless Universal Serial Bus (WUSB) and WiNet (Internet Protocol over UWB), as well as Bluetooth™ over ultra wide band. Examples of other standards related to UWB may include Multi-Band Orthogonal Frequency Division Multiplexing (MB-OFDM) and Direct Sequence UWB (DS-UWB).

Additionally, or alternatively, the communication between user devices 210 and/or network 230 may use a wireless fidelity (WiFi) network or another type of wireless network that includes another device (e.g., a server and/or wireless router) to facilitate communication between user devices 210. In some implementations described herein, user device 210 may automatically select a wireless network interface among different types of wireless network interfaces that are available on user device 210 for transferring information. User device 210 may select the wireless network interface based on a variety of factors, including, for example, the wireless network interface with the smallest power consumption.

As shown in FIG. 2B, environment 200B may include user device 210-1, user device 210-2, network 230, and an application server 240. User device 210-1, user device 210-2, and network 230 are described with regard to FIG. 2A.

Application server 240 may include one or more server devices, or other types of computational or communication devices, that gather, process, search, store, and/or provide information in a manner described herein. For example, application server 240 may store identification information for user devices 210; information about the relationship between different user devices 210; content being played by user device 210; applications being used by user device 210; and/or information about which other user devices 210 may share the applications and/or content being used by user device 210.

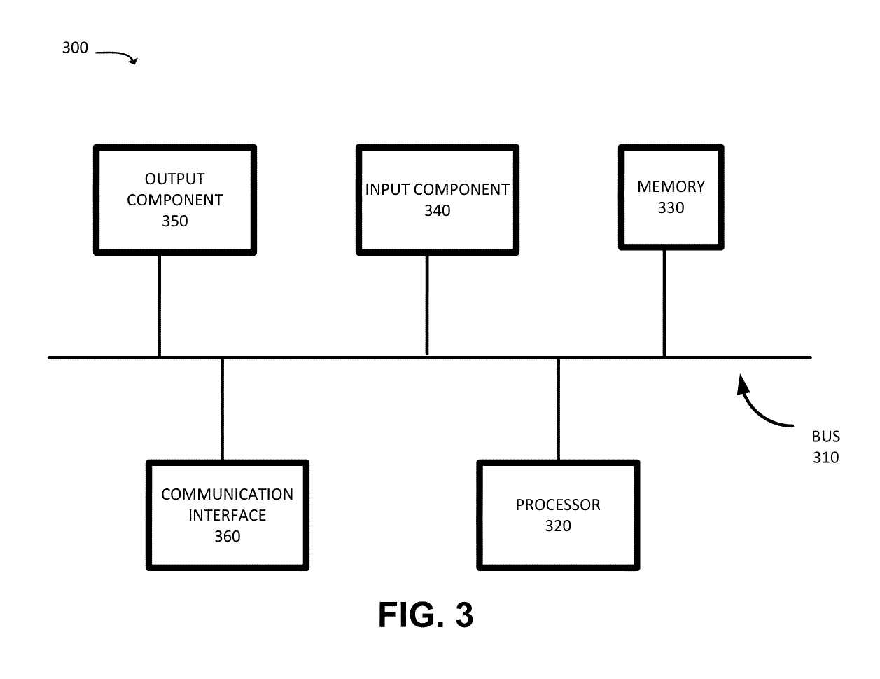

FIG. 3 is a diagram of example components of a device 300. Device 300 may correspond to user device 210 and/or application server 240. Alternatively, or additionally, user device 210 and/or application server 240 may include one or more devices 300 and/or one or more components of device 300.

As shown in FIG. 3, device 300 may include a bus 310, a processor 320, a memory 330, an input component 340, an output component 350, and a communication interface 360. In other implementations, device 300 may contain fewer components, additional components, different components, or differently arranged components than depicted in FIG. 3. Additionally, or alternatively, one or more components of device 300 may perform one or more tasks described as being performed by one or more other components of device 300.

Bus 310 may include a path that permits communication among the components of device 300. Processor 320 may include one or more processors, microprocessors, or processing logic that interprets and executes instructions. Memory 330 may include any type of dynamic storage device that stores information and instructions, for execution by processor 320, and/or any type of non-volatile storage device that stores information for use by processor 320.

Input component 340 may include a mechanism that permits a user to input information to device 300, such as a keyboard, a keypad, a button, a switch, etc. Output component 350 may include a mechanism that outputs information to the user, such as a display, a speaker, one or more light emitting diodes (LEDs), etc.

Communication interface 360 may include any transceiver-like mechanism that enables device 300 to communicate with other devices and/or systems. For example, communication interface 360 may include an Ethernet interface, an optical interface, a coaxial interface, a wireless interface, or the like.

In another implementation, communication interface 360 may include, for example, a transmitter that may convert baseband signals from processor 320 to radio frequency (RF) signals and/or a receiver that may convert RF signals to baseband signals. Alternatively, communication interface 360 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communication interface 360 may connect to an antenna assembly (not shown in FIG. 3) for transmission and/or reception of the RF signals. The antenna assembly may include one or more antennas to transmit and/or receive RF signals over the air. The antenna assembly may, for example, receive RF signals from communication interface 360 and transmit the RF signals over the air, and receive RF signals over the air and provide the RF signals to communication interface 360. In one implementation, for example, communication interface 360 may communicate with network 230 and/or devices connected to network 230.

As will be described in detail below, device 300 may perform certain operations. Device 300 may perform these operations in response to processor 320 executing software instructions (e.g., computer program(s)) contained in a computer-readable medium, such as memory 330, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

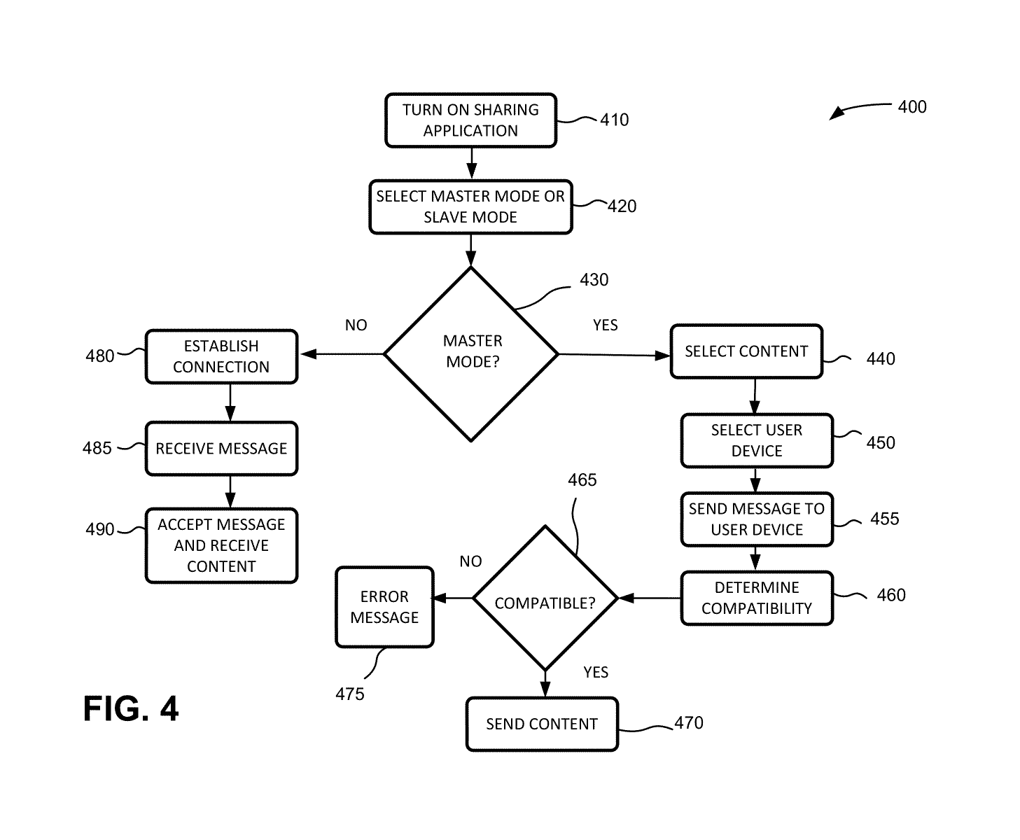

FIG. 4 is a flow chart of an example process 400 for sending and receiving content. In one implementation, process 400 may be performed by a user device, such as user device 210. In another implementation, one or more blocks of process 400 may be performed by one or more other devices, such as, application server 240.

Process 400 may include turning on a sharing application on a user device (block 410). For example, user device 210 may have a sharing application implemented in the memory of user device 210. The sharing application may allow user device 210 to share content, being played on user device 210, with other user devices 210. The sharing application may also allow user device 210 to receive content from another user device 210 that has content to share.

In one example implementation, the sharing application may automatically turn on upon user device 210 being turned on. In another example implementation, the sharing application may be turned on when instructed by a user of user device 210. For example, there may be an icon (or any other indicator) on the display of user device 210 that, when selected, may turn on the sharing application.

Process 400 may include selecting a master mode or a slave mode (block 420). For example, the sharing application may allow a user, of user device 210, to select a master mode that allows user device 210 to share content, being played on user device 210, with other user devices 210. The sharing application may allow a user, of user device 210, to operate user device 210 in a slave mode that allows user device 210 to receive content from another user device 210 that has content to share. In one example implementation, the sharing application may automatically place user device 210 into the slave mode when the master mode is not selected. In another example implementation, the sharing application may provide a slave mode selection option to place user device 210 in the slave mode.

In some implementations, user device 210 (either in slave or master mode) may register with application server 240. When registering with application server 240, user device 210 may transmit, to application server 240, the transcoding capability of user device 210, an identifier for user device 210, and an indication of the mode (slave or master) of user device 210.

When the master mode is selected (block 430—YES), process 400 may include selecting content (block 440). User device 210 may obtain selection of the content that user device 210 (to be referred to as “master user device”), in the master mode, may share with other user devices 210.

There are several ways that the master user device may obtain the content. For example, the master user device may have the content (e.g., a movie, a song, etc.) already saved on the master user device. Additionally, or alternatively, the master user device may download the content from a content provider. For example, a user of the master user device may want to play content (e.g., a movie) that requires establishing a connection to a content provider via a network, such as network 230. The master user device may access network 230 and, via network 230, establish a connection to the content provider. The master user device may download, or stream, the content from the content provider.

Additionally, alternatively, the master user device may play content that is downloaded from a memory device. The memory device could be a detachable memory device (e.g., a memory stick), a diskette, an optical compact disc, a compact disc, a video cassette, or any other device that can store content. The transfer of content from the memory device to the master user device may occur when the memory device is attached to the master user device. Additionally, or alternatively, the transfer of content from the memory device to the master user device may occur through network 230.

The master user device may play the content on a display of the master user device and/or via a speaker of the master user device. The sharing application permits the user to select a part, or all, of the content playing on the master user device, that the master user device may share with other user devices 210. For example, the master user device may be playing a movie. A user, of the master user device, may wish to share a portion of the movie playing on the master user device. The user, of the master user device, may select the sharing application. The user of master user device may use the sharing application to select a portion of the movie playing on the master user device.

For example, the sharing application may include a feature that may allow for cutting, cropping, and/or any other type of mechanism that would allow for segmenting a portion of content displayed on the screen. The user, via the sharing application, may select the desired area of displayed content by moving any type of cursor or indicator around the screen. The user, via the sharing application, may select the desired area of displayed content by touching the screen, using a remote control, using a keyboard, using a mouse, or using any other device to select the displayed content of user device 210.

Additionally, or alternatively, the sharing application may allow for sharing portions of the content playing on the master user device, such as the audio portion, the video portion, or a textual portion. For example, the master user device may be playing a movie. A user, of the master user device, may, using the sharing application, select the visual portion of the movie, and not the audio portion of the movie, to be shared with another user device 210.

Additionally, or alternatively, the sharing application may allow for the selection of a time portion of the content, playing on the master user device, that the master user device can share with another user device 210. The user, of the master user device, may, for example, enter 15 minutes as the amount of time that the other user device 210 can share the movie playing on user device 210. For example, the user, of the master user device, may wish to share the first, last, or next 15 minutes of the movie, playing on the master user device, with user device 210. Additionally, or alternatively, the user, of the master user device, may wish to share a portion of the movie corresponding to a particular time period (e.g., a portion from time A to time B), playing on the master user device, with the other user device 210.

Process 400 may include selecting a user device with which to share content (block 450). The user, of the master user device, may be given an option of sharing content, playing on the master user device, with one or more other user devices 210. For example, the user may be given an option of selecting user devices 210 that are local to the master user device. For example, user device 210 may discover other user devices 210 via Bluetooth™ and/or WiFi. User device 210 may select a specific user device 210 with which to share content; a group of user devices 210 with which to share content; or all available user devices 210 with which to share content.

Additionally, or alternatively, the user may be given an option of sharing content, playing on the master user device, with user devices 210 that are selected from a list of user devices 210. The list of user devices 210 may be stored in the memory of the master user device. For example, a user, of the master user device, may select one or more user devices 210 from the list, of user devices 210, that is stored in an address book, in the sharing application, in the memory of the master user device, and/or any application in the master user device. From the list of user devices 210, the master user device may select a specific user device 210 with which to share content; a group of user devices 210 with which to share content; or all available user devices 210 with which to share content.

Additionally, or alternatively, the user may be given an option of sharing content, playing on the master user device, with user devices 210, selected from a list of user devices 210 stored on application server 240. For example, a user, of the master user device, may select one or more user devices 210 from the list, of user devices 210, that is stored on application server 240. The master user device may communicate with application server 240 to receive the list of available user devices 210. From the list of available user devices 210, from application server 240, the master user device may select a particular user device 210 with which to share content; a group of user devices 210 with which to share content; or all available user devices 210 with which to share content.

Additionally, or alternatively, the user may be given an option of sharing content, playing on user device 210, with user devices 210 that recently interacted with the master user device. For example, user device 210 may select user devices 210 (from a list, of user devices 210, stored by the master user device and/or application server 240) which recently (e.g., in the last day, week, or any other time period) interacted with the master user device. For example, the list of user devices 210 may include user devices 210 that were in slave mode and interacted with the master user device. Additionally, or alternatively, the list of user devices 210 may include user devices 210 that were in master mode that interacted with the master user device when the master user device was acting as a slave user device. From the list of available user devices 210, user device 210 may select a specific user device 210 with which to share content; a group of user devices 210 with which to share content; or all available user devices 210 with which to share content.

Process 400 may include sending a request message to share content with another user device 210 (block 455). In one example implementation, the master user device may send a request message to another user device 210 with which the user, of the master user device, would like to share content. The request message may be a textual message, a visual message, an audio message, or a message that is a combination of one or more audio, visual, and textual elements. The request message may include information that identifies the master user device, that identifies the other user device 210, that identifies the content (playing on the master user device) that is to be shared, and/or any other information. The user, of the other user device 210 may accept, or deny, the request to share content from the master user device.

In another example implementation, application server 240 may send a request message to the other user device 210 with which the user of the master user device would like to share content. The master user device may send an identifier for the other user device 210, the content (including format and/or a content identifier), and the transcoding capability of the master user device to application server 240. Application server 240 may use the identifier for the other user device 210 to send the request message to the other user device 210.

The request message may be a textual message, a visual message, an audio message, or a message that is a combination of one or more audio, visual, and textual elements. The request message may include information that identifies the master user device, that identifies the other user device 210, that identifies the content (playing on the master user device) that is to be shared, and/or any other information. The user, of the other user device 210, may accept, or deny, the request to share content from the master user device.

Process 400 may include determining the compatibility of the content (block 460). For example, the content may be compatible between the master user device and the other user device 210, or the content may require transcoding to be compatible between the master user device and the other user device 210. Transcoding may convert the format of the content (pictures, text, video, and/or audio) on one device (the master user device) to be compatible on another user device (the other user device 210). Alternatively, the master user device, or the other user device 210, may not be able to transcode the content. In this case, the content may not be compatible between the master user device and the other user device 210.

In one example implementation, application server 240 may determine the compatibility of the content. Application server 240 may determine the compatibility of the content by using the transcoding capability of the master user device; the transcoding capability of the other user device 210; and the content format (e.g., the data format of the content capable of being played on the master user device and the other user device 210).

Application server 240 may determine that the content is compatible between the master user device and the other user device 210. Application server 240 may determine that the master user device should transcode the content, for the content to be compatible between the master user device and the other user device 210. Alternatively, application server 240 may determine that the other user device 210 should transcode the content, for the content to be compatible between the master user device and user device 210. Alternatively, application server 240 may determine that the master user device and the other user device 210 are not capable of transcoding the content.

In another example implementation, the sharing application on the master user device may determine the compatibility of the content. The sharing application (on the master user device) may determine the compatibility of the content by using the transcoding capability of the master user device; the transcoding capability of the other user device 210; and the content format (e.g., the data format of the content capable of being played on the master user device and the other user device 210).

The sharing application may determine that the content is compatible between the master user device and the other user device 210. The sharing application may determine that the master user device should transcode on the content, for the content to be compatible between the master user device and the other user device 210. Alternatively, the sharing application may determine that the other user device 210 should transcode to the content, for the content to be compatible between the master user device and the other user device 210. Alternatively, the sharing application, on the master user device, may determine that the master user device and the other user device 210 are not capable of transcoding the content.

If the content is compatible (block 465—YES), process 400 may include sending the content (block 470). For example, the master user device may send the content as a data stream. The data stream may include the content, playing on the master user device, that the user, of master user device, wants to share with the other user device 210. The content may be compatible between the master user device and the other user device 210. Alternatively, the master user device may transcode the content so that the content is compatible with the other user device 210. Alternatively, the master user device may send the content and the other user device 210 may transcode the content.

In one example implementation, the content may be sent to application server 240. The content may be stored in application server 240. The master user device may also send other information, such as identification information (e.g., an alias) for the master user device and/or other user devices 210 that may share the content playing on the master user device; the transcoding capability of the master user device; an identifier associated with the content; a format of the content; information about the relationship between the master user device and user devices 210; information identifying content playing on the master user device that can be shared in whole, or in part, with other user devices 210; and/or information identifying applications being used by the master user device and/or other user devices 210. The other user device 210 may receive the content, from application server 240. By using the sharing application, executed on the other user device 210, the other user device 210 may play the content that is playing on the master user device.

In another example implementation, the master user device may automatically connect (e.g., via Bluetooth™ or another communication protocol) with the other user device 210 and send the content to the other user device 210. The master user device may send the data stream to any user device 210 that has been selected by the master user device with which to share content playing on the master user device. The other user device 210 may receive the content, from the master user device. By using the sharing application, executed on the other user device 210, the other user device 210 may play the content that is playing on the master user device.

If the content is not compatible (block 465—NO), process 400 may include sending an error message (block 475). For example, an error message may be sent to the master user device and/or the other user device 210 that the content may not be shared between the two user devices. In one example implementation, application server 240 may send the error message to the master user device and/or the other user device 210. In another example implementation, the master user device may display an error message for the user, of the master user device, to view, and/or send the error message to the other user device 210.

When the slave mode is selected (block 430—NO), process 400 may include establishing a connection (block 480). For example, user device 210, that is in slave mode, (to be referred to as “slave user device”) may send a request to network 230, via communication interface 360 (described with regard to FIG. 3) to establish the connection to network 230. The request to establish the connection to network 230 may be accepted and the slave user device may establish the connection and connect to network 230.

Process 400 may include receiving the message (block 485). For example, the slave user device may receive a request message from user device 210 that has selected a master mode (to be referred to as “master user device”). The master user device may send the request message to the slave user device, requesting to share content, playing on the master user device, with the slave user device.

In one example implementation, the slave user device may receive a request message from the master user device that the user, of the master user device, would like to share content, playing on the master user device, with the slave user device. The request message may be a textual message, a visual message, an audio message, or a message that is a combination of one or more audio, visual, and textual elements. The request message may include information that identifies the master user device, that identifies the other user device 210, that identifies the content (playing on the master user device) that is to be shared, and/or any other information. The slave user device may receive more than one request message from multiple master user devices that can share content with the slave user device.

In another example implementation, the slave user device may receive a request message from application server 240 that the user, of master user device, would like to share content, playing on the master user device, with the slave user device. The request message may be a textual message, a visual message, an audio message, or a message that is a combination of one or more audio, visual and textual elements. The request message from application server 240 to the slave user device may include information about the content, playing on the master user device, that the user of the master user device would like to share with the slave user device. The request message may include information that identifies the master user device, that identifies the other user device 210, that identifies the content (playing on the master user device) that is to be shared, and/or any other information. The slave user device may receive more than one request message from application server 240 about multiple master user devices that can share content with the slave user device.

Process 400 may include accepting the request message and receiving content (block 490). For example, a user of the slave user device may accept the request message and receive content that is playing on the master user device. The slave user device may transcode the content. Alternatively, the content may be transcoded by the master user device before the content is sent to the slave user device.

The slave user device may play the content. The user of the slave user device may then view and/or listen to some, or all, of the content. In one example implementation, the slave user device may receive the content from the master user device. In another example implementation, the slave user device may receive the content from application server 240.

In one implementation, the slave user device may play the content and permit the user to only stop the playing of the content. In another implementation, the slave user device may provide the user with additional control over the playing of the content. For example, the slave user device may permit the user to rewind, fast forward, pause, stop, and/or resume the playing of the content on the slave user device.

Additionally, or alternatively, the slave user device may stop playing the content when the master user device stops playing the content. For example, the master user device may stop playing the content when the master user device is turned off, loses network connection, or no longer has enough power to stay on. Also, the master user device may stop playing the content when the user, of the master user device, decides to stop playing the content on the master user device.

In one example implementation, application server 240 may stop sending the content to the slave user device when the master user device stops playing the content. Additionally, or alternatively, application server 240 may send a message to the slave user device to notify the slave user device that the master user device has stopped playing the content that was being shared with the slave user device. In response to application server 240 not sending the content to the slave user device, or in response to receipt of the message by the slave user, the slave user device may stop playing the content.

In another example implementation, the master user device may stop sending the content to the slave user device when the master user device stops playing the content. Additionally, or alternatively, the master user device may send a message to the slave user device to notify the slave user device that the master user device has stopped playing the content that was being shared with the slave user device. In response to the master user device not sending the content to the slave user device, or in response to receipt of the message by the slave user device, the slave user device may stop playing the content.

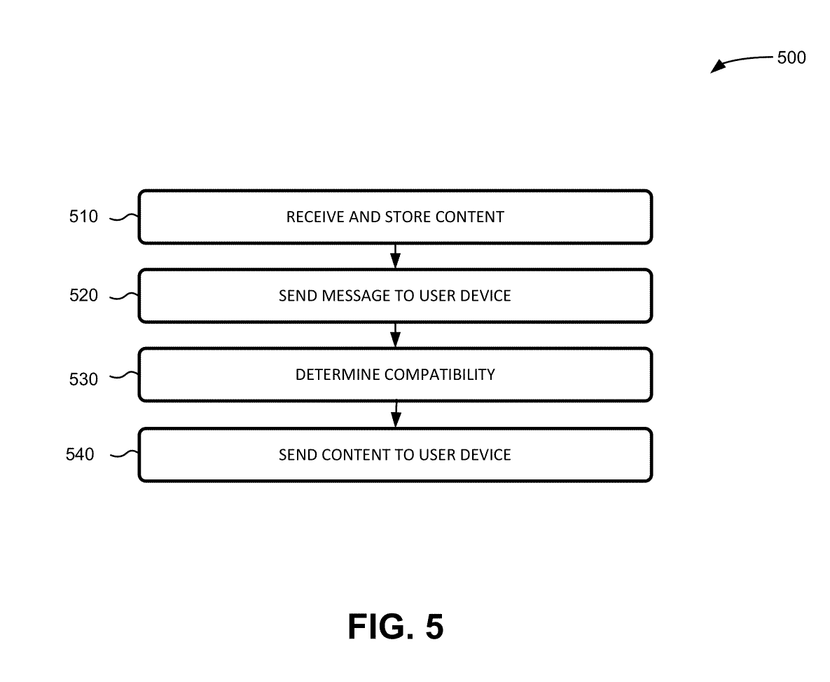

FIG. 5 is a flow chart of an example process 500 for receiving and sending content by using an application server. In one implementation, process 500 may be performed by application server 240. In another implementation, one or more blocks of process 500 may be performed by one or more other devices, such as user device 210.

Process 500 may include receiving and storing content (block 510). For example, application server 240 may receive and store content from a user device 210 that is in master mode (to be referred to as “master user device”). Application server 240 may also receive other information, such as registration of identification information for the master user device and/or other user devices 210; identification of whether user device 210 is in master mode or slave mode; the transcoding capability of the master user device; content playing on the master user device that can be shared in whole, or in part, with other user devices 210; identifier associated with the content; the format of the content; applications being executed by the master user device; and/or information about which other user devices 210 may share the applications and/or content playing on the master user device.

Process 500 may include sending a message to the user device (block 520). For example, application server 240 (or the master user device) may send a request message to another user device 210, that is in slave mode (to be referred to as “slave user device”), indicating that the master user device has content, playing on the master user device, that may be shared with the slave user device. The request message may include information, such as the information described previously. The slave user device may receive more than one request message from application server 240 about multiple master user devices that can share content with the slave user device. The slave user device may accept the request message and send an acknowledgement of acceptance to application server 240 or the master user device.

Process 500 may include determining the compatibility of the content (block 530). For example, the content may be compatible between the master user device and the slave user device, or the content may require transcoding. Transcoding may convert the format of the content (pictures, text, video, and/or audio) on one device (e.g., the master user device) to be compatible on another user device (e.g., the slave user device). Alternatively, the content may not be compatible (e.g., the content cannot be transcoded to a format that is capable of being played on the slave user device).

Application server 240 may determine the compatibility of the content by using the transcoding capability of the master user device; the transcoding capability of the slave user device; and the content format (e.g., the data format of the content capable of being played on the master user device and the slave user device).

Application server 240 may determine that the content is compatible between the master user device and the slave user device. Alternatively, application server 240 may determine that the master user device should transcode the content, for the content to be compatible between the master user device and the slave user device. Alternatively, application server 240 may determine that the slave user device should transcode the content, for the content to be compatible between the master user device and the slave user device.

Alternatively, application server 240 may determine that the master user device and the slave user device are not capable of transcoding the content. In this case, application server 240 may send an error message, described with regard to block 465 in FIG. 4.

Process 500 may include sending content to the user device (block 540). In one example implementation, application server 240 may send content (playing on the master user device) to the slave user device when the slave user device accepts the request message to share content, playing on the master user device, from application server 240. In another example implementation application, server 240 may communicate to the master user device that the slave user device has accepted the request to share content. The master user device may then send content to the slave user device.

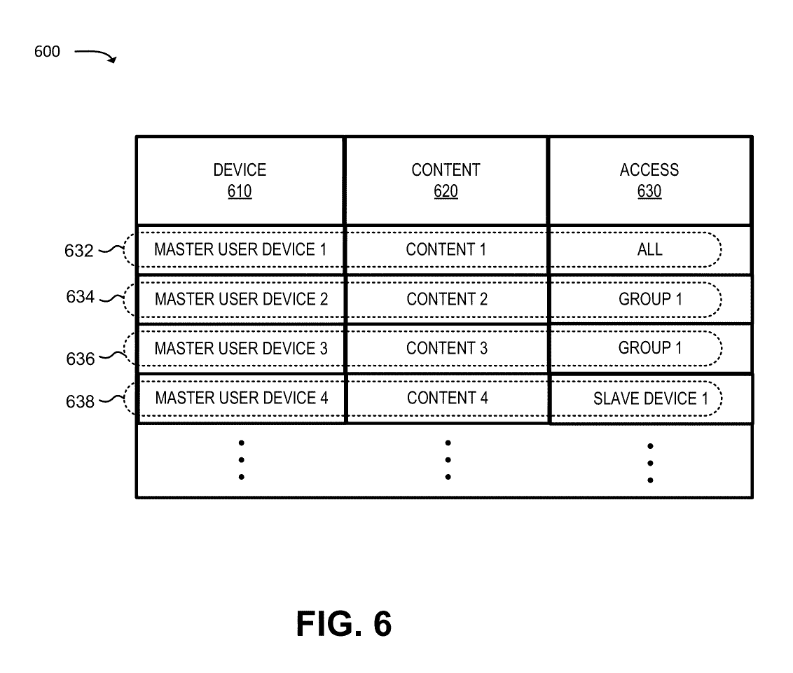

FIG. 6 is a diagram of an example data structure 600 that stores information used to share content on one or more user devices with other user devices. In one example implementation, application server 240 may store some or all of data structure 600. Alternatively, or additionally, user device 210 may store some or all of data structure 600. Additionally, or alternatively, data structure 600 may be stored in memory, associated with another device or a group of devices, separate from or in combination with the memory associated with application server 240 and/or user device 210.

Data structure 600 may include a collection of fields, such as a device field 610, content field 620, and access field 630. Although FIG. 6 shows example fields 610-630, in other implementations, data structure 600 may include fewer fields, different fields, additional fields, and/or differently arranged fields than depicted in FIG. 6. Additionally, or alternatively, one or more fields of data structure 600 may include information described as being included in one or more other fields of data structure 600.

Device field 610 may store information from a user device 210 that selected the master mode, described with regard to FIG. 4. Device type field 610 may store an alias, name, or any other unique identifier for a master user device, such as user device 210. As shown within ellipse 632 in the example of FIG. 6, an alias for user device 210 may be “master user device 1.”

Content field 620 may store content being played on user device 210 that selected the master mode, described with regard to FIG. 4. Content field 620 may store content that was selected, using the sharing application, by user device 210, described with regard to FIG. 4. For example, content 1 (ellipse 632) may be a movie playing on master user device 1. In another example, content 1 (ellipse 632) may only be the audio portion associated with content played on master user device 1. Content field 620 may include an identifier for the content, information about the format of the content, and the transcoding capabilities of different user devices (e.g., master user device 4 and slave device 1 in ellipse 638) to allow sharing of the content between two user devices.

Access field 630 may store particular information about which user devices 210 may obtain the content, identified in content type field 620, from user device 210 described in device type field 610. The selected user devices 210, in access field 630, may include user devices 210 that have been selected, as described with regard to FIG. 4.

In one example implementation, application server 240 may receive content 1 (as shown by ellipse 632 and content field 620) from master user device 1. Master user device 1 may correspond to user device 210 which selected the master mode, described with regard to FIG. 4. Content 1 may correspond to content that master user device 1 is playing. Master user device 1 may determine what constitutes content 1, described with regard to FIG. 4. For example, content 1 may be a movie playing on master user device 1. Master user device 1 may determine what other user devices 210 may access content 1 (e.g., as shown by ellipse 632 and by access field 630), described with regard to FIG. 4. For example, master user device 1 may provide access to content 1 to all user devices 210 that are available (as shown by ellipse 632).

The information shown in ellipse 632, 634, 636, and/or 638 may be removed from data structure 600 when user device 210 stops playing content associated with one of the above ellipses. For example, the information described in ellipse 636 may be removed from data structure 600 when master user device 3 (ellipse 636) stops playing content 3 (ellipse 636); when master user device 3 is turned off; when master user device 3 stops functioning; or when master user device 3 loses its network connection.

Alternatively, the information shown in ellipse 632, 634, 636, and/or 638 may be stored in data structure 600 when user device 210 stops playing the content. For example, master user device 4 (ellipse 638) may stop playing content 4 (ellipse 638). However, application server 240 may still store the information in ellipse 638 after master user device 4 stops playing content 4.

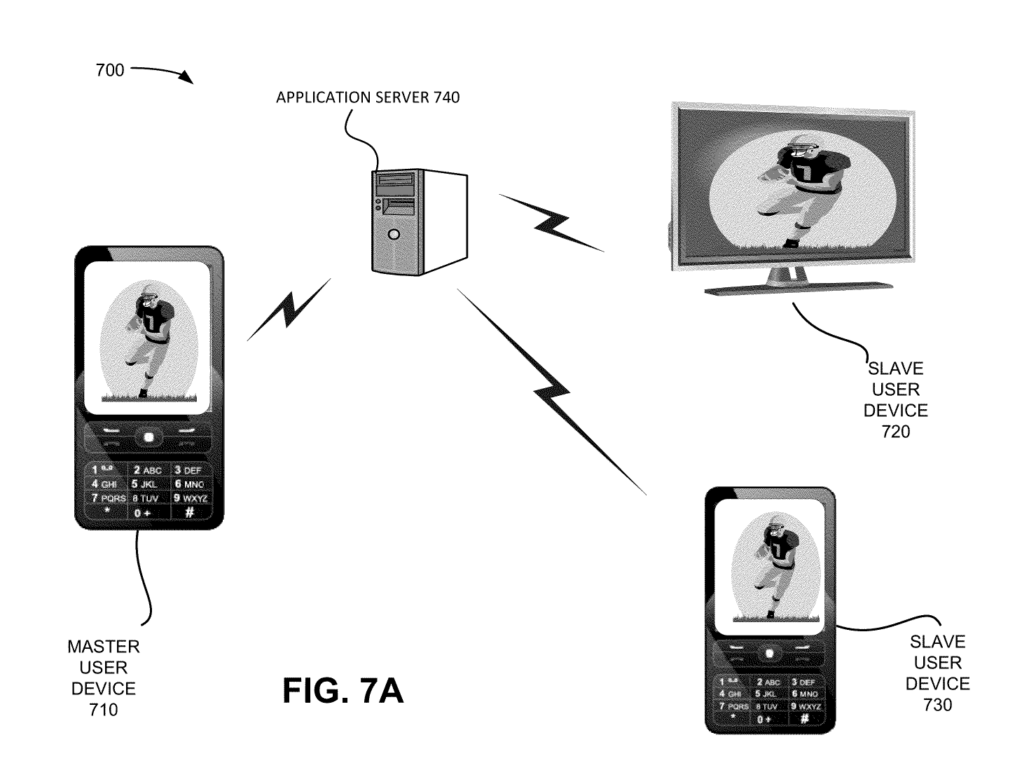

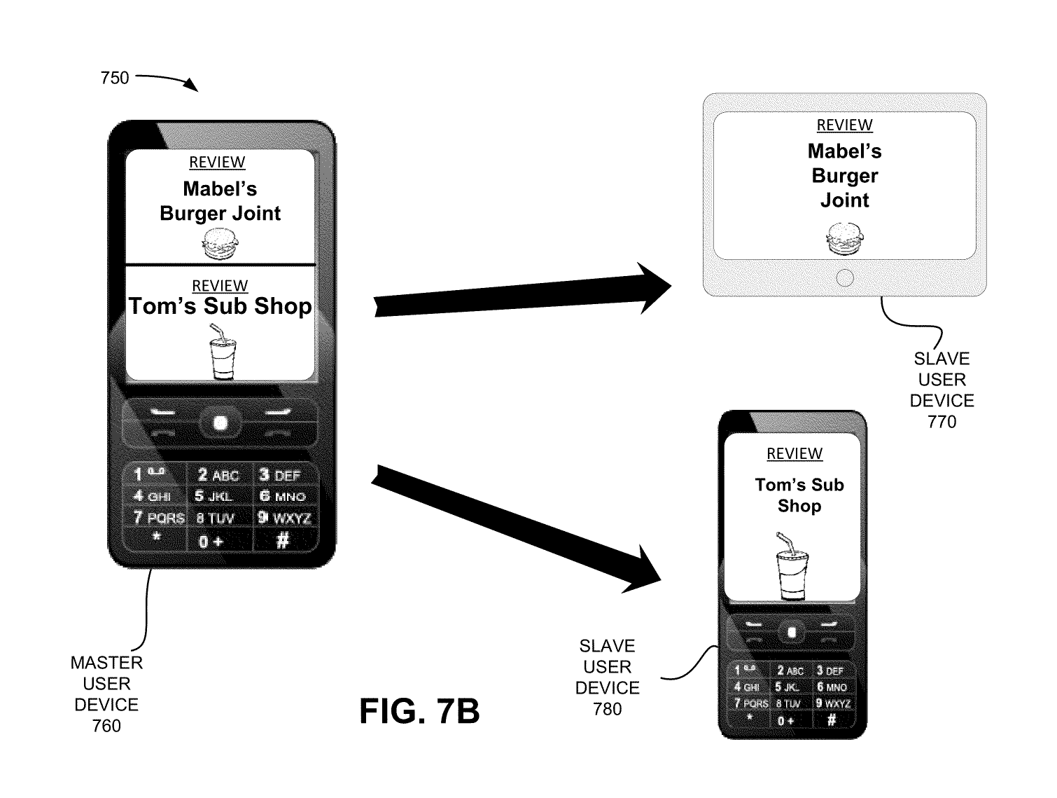

FIG. 7A is a diagram of an example process 700 for sharing content. FIG. 7A shows master user device 710, slave user device 720, slave device 730, and application server 740. An example of master user device 710 and slave user devices 720 and 730 may correspond to user device 210, described with regard to FIGS. 2A-2B. An example of application server 740 may correspond to application server 240, described with regard to FIGS. 2A-2B.

As shown in FIG. 7A, master user device 710 may be a smart phone. Assume that the user (“John”), of master user device 710, is watching a football game on master user device 710. John may decide that he would like to share his experience (watching the football game) with his two friends. Assume that John and his two friends are all located in different geographic locations. For example, John may be in New York, one friend may be in California, and the other friend could be in Texas. One friend may have slave user device 720 that is a television with a set top box (STB), and the other friend may have slave user device 730 that is a smart phone.

John may decide to execute a sharing application on master user device 710. The sharing application may permit John to select the football game, playing on master user device 710, to be shared with slave user devices 720 and 730. To begin the process of sharing the football game with his friends, John may select a master mode option in the sharing application. The master mode may allow John to share content, playing on master user device 710, with slave user devices 720 and 730.

Once John has selected the master mode, the sharing application may permit John to select an option to share the football game, playing on master user device 710, with slave user devices 720 and 730. The sharing application may also permit John to select an option to select a portion of the football game to share. Thus, John, may decide that he would like to share the next 20 minutes of the football game.

John may then be given an option, by the sharing application, to select with whom he would like to share the football game. John may select one or more other users from a list of available slave user devices that can share the football game playing on master user device 710. The list, of available slave user devices, may be stored in an address book in master user device 710. John chooses, from the list, his friends' slave user devices 720 and 730 with which he would like to share the football game.

Slave user devices 720 and 730 may each be executing a sharing application. Assume that slave user devices 720 and 730 are each operating in the slave mode. The slave mode may allow slave user devices 720 and 730 to receive and play content that is playing on master user device 710.

Master user device 710 may send the football game content, associated with the selected portion, and the identifiers for the selected slave user devices 720 and 730 to application server 740. Application server 740 may store the football game content and the identifiers for slave user devices 720 and 730. Application server 740 may then send a request message to slave user device 720 and slave user device 730.

The request message may be displayed on slave user devices 720 and 730. The request message to each friend may be: “Hello, this is John123. John123 would like to share the Miami v. Dallas game.” The friend, associated with slave user device 730 may receive and view the message on the smart phone display. The friend, with the television, may receive the message, via the STB, and view the message on the television screen. The friends, using slave user devices 720 and 730, may each accept the invitation from John.

Upon accepting the request message from master user device 710, to receive content playing on master user device 710, slave user device 720 and slave user device 730 may each receive the football game content from application server 740. When the football game content is not compatible for playing on slave user devices 720 and 730, the football game content may be transcoded (by master user device 710 or slave user devices 720 and 730) so that the football game content is compatible for sharing by master user device 710 and slave user devices 720 and 730. Each of John's friends may now watch, on their slave user devices 720 and 730, the selected portion of the football game that is also being watched by John on master user device 710.

FIG. 7B is a diagram of an example process 750 that shows master user device 760, slave user device 770, and slave user device 780. An example of master user device 760 may correspond to user device 210, described with regard to FIGS. 2A-2B. An example of slave user devices 770 and 780 may correspond to user device 210, described with regard to FIGS. 2A-2B. As shown in FIG. 7B, master user device 760 may be a smart phone. Assume that the user (“Jane”), of master user device 760, may be viewing reviews of restaurants that are on a web page. The web page displays a review for a burger restaurant, and a review for a sub sandwich shop. Jane would like to share the web page with her older sister and her younger sister. Jane's two sisters each have a respective slave user device 770 and 780.

Assume that master user device 760, slave user device 770 and slave user device 780 may be located in the same house. Jane, who is using master user device 760, is in the kitchen; the older sister, who is using slave user device 770 (the tablet), is in the living room; and the younger sister, who is using slave user device 780 (the smart phone), is in the basement. Assume that master user device 760 will communicate with slave user device 770 and 780, via a local communication protocol, such as WiFi or Bluetooth™.

Jane may decide to select a sharing application on master user device 760. The sharing application may permit Jane to share the web page, displayed on master user device 760, with slave user devices 770 and 780. To begin sharing the web page, Jane may select a master mode option in the sharing application. The master mode will allow Jane to share web page, that is displayed on master user device 760, with slave user devices 770 and 780.

Once Jane has selected the master mode, the sharing application may permit Jane to select an option to share the web page, on master user device 760, with slave user devices 770 and 780. The sharing application may also permit Jane to select an option to select a portion of the web page, displayed on master user device 760, with slave user device 770 and 780. Thus, Jane may use the sharing application to split the web page into two portions—the review for Mabel's Burger Joint and the review for Tom's Sub Shop.

Jane may then select with whom she would like to share each portion of the web page. Jane may select one or more users from a list of available slave user devices that can share the web page displayed on master user device 760. For example, the list, of available slave user devices 770 and 780, may be stored in an address book in master user device 760. Jane may choose, from the list, her older sister's slave user device 770 and her younger sister's slave user device 780 with which Jane would like to share portions of the web page. Thus, Jane may select to share the review for “Mabel's Burger Joint” with her older sister, and Jane may select to share the review for “Tom's Sub Shop” with her younger sister.

Slave user device 770 and 780 may each be executing a sharing application. Assume that slave user devices 770 and 780 are each operating in the slave mode. The slave mode may allow slave user devices 770 and 780 to receive and display the web page that is displayed on master user device 760.

Slave user devices 770 and 780 may receive a request message from Jane's master user device 760 that there is a web page, displayed on master user device 760, which is available for sharing. The request message displayed on the older sister's slave user device 770 may be: “Hello, this is Jane867. Jane867 would like to share a review of Mabel's Burger Joint.” The request message displayed on the younger sister's slave user device 780 may be: “Hello, this is Jane867. Jane867 would like to share a review of Tom's Sub Shop.”

Both the older sister and the younger sister may accept the request to share the web page being displayed on Jane's master user device 760. Upon the older sister, who is using slave user device 770, accepting the request, master user device 760 may send the review for “Mabel's Burger Joint” to the older sister's slave user device 770. Upon the younger sister, who is using slave user device 780, accepting the request, master user device 760 may send the review for “Tom's Sub Shop” to the younger sister's slave user device 780. When the web page is not compatible for playing on slave user devices 770 and 780, master user device 760 (or slave user devices 770 and 780) may transcode to the web page so that each portion of the web page is compatible for viewing on slave user devices 770 and 780. Both the older and younger sisters may now view the restaurant reviews on their respective slave user devices 770 and 780.

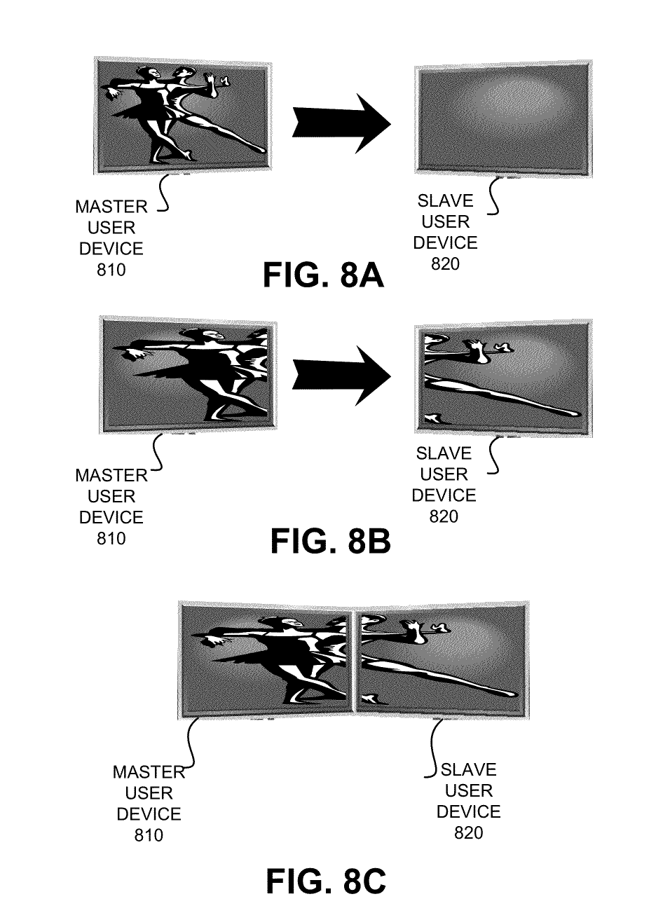

FIGS. 8A-8C are diagrams of an example process for sharing content. FIGS. 8A-8C show a master user device 810, and slave user device 820. An example of master user device 810 may correspond to user device 210, described with regard to FIGS. 2A-2B. An example of slave user device 820 may correspond to user device 210, described with regard to FIGS. 2A-2B.

FIG. 8A shows of a master user device 810 and a slave user device 820. For example, master user device 810 and slave user device 820 may be tablet devices. Assume that the user (“Mary”), of master user device 810, may be watching a video about ballet. Mary would like to share the video with her husband, who is using slave user device 820. Assume that Mary and her husband are both located in the same room of their house.

Mary may decide to execute a sharing application on master user device 810. The sharing application may permit Mary to select content, playing on master user device 810, to be shared with slave user device 820. To begin sharing content, Mary may select the master mode option in the sharing application. The master mode may allow Mary to share content, playing on master user device 810, with slave user device 820.

Once Mary has selected the master mode, the sharing application may permit Mary to select an option to share the video, playing on master user device 810, with her husband. The sharing application may also permit Mary to select a portion of the video, playing on master user device 810, to share with slave user device 820. By using the sharing application, Mary may select one portion of the video to be displayed on master user device 810, and Mary may also select another portion of the video to be displayed on slave user device 820.

Mary may then select with whom she would like to share the portion of the video. Mary may select from a list of available slave user devices that can share the video playing on master user device 810. For example, the list, of available slave user devices, may be a list of available slave user devices in the area that are discovered (e.g., using Bluetooth™) by master user device 810. Assume that the sharing application is executed on slave user device 820. The sharing application may allow slave user device 820 to play content that is playing on master user device 810. In this example, Mary may choose, from the list, her husband's slave user device 820.

Mary may send a request message to be displayed on slave user device 820 that is being used her husband. Assume that master user device 810 is communicating with slave user device 820, via Bluetooth™, as described previously. The request message may be: “Hello, this is Mary755. Mary755 would like to share a video with you.” Slave user device 820 may receive the request message from master user device 810.

Turning now to FIG. 8B, the husband, using slave user device 820, may accept the request to share the video that is playing on master user device 810. While the husband may accept the request to share the video, the husband may also have the option to decline to accept the request to share the video. Slave user device 820 may receive and play the portion of the video playing on master user device 810.

Turning now to FIG. 8C, Mary may decide to bring master user device 810 into close vicinity of slave user device 820. Mary may decide that she would like to see a bigger display of the video than what she is watching on master user device 810. Mary may bring master user device 810 into close vicinity to her husband's slave user device 820. By bringing master user device 810 and slave user device 820 close to each other, the effective size of the display of the video may appear to be expanded to the combined size of the display screen of master user device 810 and the display screen of slave user device 820.

The foregoing description of implementations provides illustration and description, but is not intended to be exhaustive or to limit the implementations to the precise form disclosed. Modifications and variations are possible in light of the above disclosure or may be acquired from practice of the implementations.

While series of blocks have been described with regard to FIGS. 4 and 5, the order of the blocks may be modified in other implementations. Further, non-dependent blocks may be performed in parallel.

While, as described above, one master user device may share content with multiple slave user devices, or one master user device may share content with one slave user device, there may be multiple master user devices sharing content with one slave user device, and/or multiple master user devices sharing content with multiple slave user devices.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system comprising:
a first user device to:
play content,
receive selection of a portion of the content, the portion of the content being less than an entirety of the content,
receive selection of a second user device with which to share the portion of the content,
determine whether the portion of the content is compatible for playing on the second user device, and
send, based on determining that the portion of the content is compatible for playing on the second user device, the portion of the content to the second user device, while the content is playing on the first user device, causing the second user device to play the portion of the content.

2. The system of claim 1, where, when sending the portion of the content to the second user device, the first user device is to send the portion of the content directly to the second user device.

3. The system of claim 1, where, when determining whether the portion of the content is compatible for playing on the second user device, the first user device is to:
determine a transcoding capability of the first user device,
determine a transcoding capability of the second user device,
select, based on the transcoding capability of the first user device and the transcoding capability of the second user device, one of the first user device or the second user device to transcode the portion of the content.

4. The system of claim 1, where, when receiving selection of the portion of the content, the first user device is to receive information identifying a time period associated with the content, the time period being less than an entire time period associated with the content.

5. The system of claim 1, where, when sending the portion of the content to the second user device, the first user device is to send the portion of the content to a server, the server sending the portion of the content to the second user device.

6. The system of claim 1, where, when receiving selection of the second user device, the first user device is to:
discover a plurality of user devices located in a geographic area of the first user device, and
receive the selection of the second user device from the plurality of user devices.

7. The system of claim 1, where the first user device is further to:
receive selection of a second portion of the content to play on the first user device, the second portion of the content being different than the portion of the content, a combined size of the portion of the content and the second portion of the content being expanded to a combined display size of a display for the first user device and a display for the second user device.

8. A method comprising:
receiving, by a server, a portion of content from a first user device, the portion of content being less than an entirety of the content that is playing on the first user device;
receiving, by the server, information identifying a second user device with which to share the portion of content;
storing, by the server, the portion of content;
sending, by the server, a request to the second user device to share the portion of content that is playing on the first user device;
receiving, by the server, an acceptance of the request from the second user device;
determining, by the server, whether the portion of content is compatible for playing on the second user device; and
sending, based on determining that the portion of content is compatible for playing on the second user device, the portion of content, playing on the first user device, to the second user device, to cause the second user device to play the portion of content.

9. The method of claim 8, where the content includes video and the portion of the content includes audio or a portion of the video.

10. The method of claim 8, further comprising:
receiving, by the server, an indication that the first user device is no longer playing the content; and
causing, by the server and based on the indication the second user device to stop playing the portion of the content.

11. The method of claim 8, where receiving the information identifying the second user device includes storing a list of available user devices, the list including information identifying the second user device, providing the list to the first user device, and receiving a selection of the second user device from the list.

12. The method of claim 8, where determining whether the portion of content is compatible for playing on the second user device, includes instructing one of the first user device or the second user device to transcode the portion of content.

13. A computer-readable medium, comprising:
one or more instructions that, when executed by one or more processors of a device, cause the one or more processors to:
receive a portion of content from a first user device, the portion of content being less than an entirety of the content that is playing on the first user device,
store the portion of content,
send a request to a second user device that the first user device has the portion of content, playing on the first user device, that can be shared with the second user device,
receive selection from the second user device to share the portion of content that is playing on the first user device,
determine, based on the selection, whether the portion of content is compatible for playing on the second user device, and
send, based on determining that the portion of content is compatible for playing on the second user device, the portion of content to the second user device, to cause the second user device to play the portion of content.

14. The computer-readable medium of claim 13, further comprising:
one or more instructions that, when executed by the one or more processors, cause the one or more processors to:
receive an indication that the first user device is no longer playing the content, and
stop, based on the indication that the first user device is no longer playing the content, the portion of content from being sent to the second user device.

15. The computer-readable medium of claim 13, where the one or more instructions to determine whether the portion of content is compatible for playing on the second user device, include one or more instructions to:
select one of the first user device or the second user device to transcode to the portion of content.

16. The computer-readable medium of claim 13, further comprising:
one or more instructions that, when executed by the one or more processors, cause the one or more processors to:
receive information identifying the second user device, with which to share the portion of content, from the first user device.

17. The computer-readable medium of claim 16, further comprising:
one or more instructions that, when executed by the one or more processors, cause the one or more processors to:
store the information identifying the second user device.

18. A computer-readable medium, comprising:
one or more instructions that, when executed by one or more processors of a first user device, cause the one or more processors to:
receive content,
receive selection of a first portion of the content to play on the first user device,
receive selection of a second portion of the content to share with a second user device, the second portion of the content being different than the first portion of the content,
send a request to the second user device to share the second portion of the content,
receive acceptance, of the request to share the second portion of the content, from the second user device, and
send the second portion of the content to the second user device, based on receiving the acceptance from the second user device.

19. The computer-readable medium of claim 18, where a combined size of the first portion of the content and the second portion of the content is expanded to a combined display size of a display for the first user device and a display for the second user device.

20. The computer-readable medium of claim 18, where a combined size of the first portion of the content and the second portion of the content is less than a display size of a display for the first user device.
